(19) United States
(12) Patent Application Publication
(10) Pub. No.: US 2022/0207667 A1
(43) Pub. Date: Jun. 30, 2022

(54) GAZE DIRECTION CORRECTION METHOD

(71) Applicant: REALTEK SEMICONDUCTOR CORP., Hsinchu (TW)

(72) Inventors: Yi-Hsuan Huang, Hsinchu (TW); Wen-Tsung Huang, Hsinchu (TW)

(73) Assignee: REALTEK SEMICONDUCTOR CORP., Hsinchu (TW)

(21) Appl. No.: 17/210,149

(22) Filed: Mar. 23, 2021

(30) Foreign Application Priority Data
Dec. 31, 2020 (TW) 109147163

(51) Int. Cl. G06T 5/00; G06T 7/73; G06T 5/50; G06K 9/00

(52) U.S. Cl. CPC G06T 5/006; G06T 7/74; G06T 5/50; G06T 2207/20081; G06T 2207/30201; G06T 2207/20221; G06K 9/00268

(57) ABSTRACT

A gaze direction correction method is provided. The method includes: obtaining a first image; obtaining a first gaze feature according to the first image; determining whether the first gaze feature falls within a gaze zone; if the first gaze feature fails to fall within the gaze zone, obtaining, according to the first image, a second image corresponding to the first image and obtaining an eye image corresponding to the second image; obtaining a temporary image by combining the first image and the eye image; and obtaining a face output image by modifying the temporary image.

### CROSS-REFERENCE TO RELATED APPLICATION

This non-provisional application claims priority under 35 U.S.C. § 119(a) to Patent Application No. 109147163 filed in Taiwan, R.O.C. on Dec. 31, 2020, the entire contents of which are hereby incorporated by reference.

### BACKGROUND

### Technical Field

The present invention relates to a visual data processing method, and in particular, to a gaze direction correction method.

### Related Art

Nowadays, a quantity of users making a video call via electronic devices has greatly increased. During a video call, a user can watch another party's video. In this way, a sense of presence like face-to-face communication can be generated. Further, the other party's video can create a warm and friendly atmosphere that a simple voice call fails to provide. However, due to hardware limitations, usually a lens of such electronic devices for capturing images of the user is not placed at a central region but closed to the edges of the screen, while the user would tend to look at the video shown on the screen during the video call. In this configuration, it is difficult for another party to feel the sense of presentation and the atmosphere when the user does not look at the lens. That is to say, current configurations can hardly build a genuine visual communication between two parties during the video call, and the desirable experience that the video call is supposed to provide is reduced

### SUMMARY

In some embodiments, a gaze direction correction method includes: obtaining a first image; obtaining a first gaze feature according to the first image; determining whether the first gaze feature falls within a gaze zone; if the first gaze feature fails to fall within the gaze zone, obtaining, according to the first image, a second image corresponding to the first image and obtaining an eye image corresponding to the second image; obtaining a temporary image by combining the first image and the eye image; and obtaining a face output image by modifying the temporary image.

In some embodiments, the step of obtaining a face output image by modifying the temporary image includes: obtaining a difference image by calculating a pixel difference between the first image and the second image and corresponding to identical pixel positions; and obtaining the face output image by combining the second image, the difference image, and an eye contour image of the first image.

In some embodiments, a reference face image is obtained before the first image is obtained; a difference image is obtained by calculating a pixel difference between the first image and the second image and corresponding to the identical pixel positions; a sum of pixels is calculated according to pixel data of each pixel of the difference image; a comparison result is obtained by comparing the sum of pixels with a pixel threshold; a combined face image is obtained by combining the second image, the difference image, and an eye contour image of the first image; a first weight parameter corresponding to the combined face image is calculated according to the comparison result; and the face output image is obtained according to the first weight parameter, the reference face image, and the combined face image.

In some embodiments, a sum of the first weight parameter and a second weight parameter is one, and the step of obtaining the face output image according to the first weight parameter, the reference face image, and the combined face image includes: obtaining a first pixel product by multiplying the first weight parameter by pixel data of the combined face image; obtaining a second pixel product by multiplying the second weight parameter by pixel data of the reference face image; and obtaining pixel data of the face output image by adding up the first pixel product and the second pixel product.

In some embodiments, after the step of obtaining a first image, the method includes: obtaining a first gaze direction according to the first image; before the first gaze direction is determined, matching pixel data of the first image with pixel data of a plurality of human face images included in a gaze correction model, and correcting the first gaze feature according to the first image after the matching; and matching pixel data of the second image to the pixel data of the first image after the first gaze feature is corrected.

In some embodiments, after the step of obtaining a first image, the method includes: obtaining a first gaze direction according to the first image; before the first gaze direction is determined, matching the first gaze feature with gaze features of a plurality of human eye images included in a gaze correction model, and correcting the first gaze feature according to the first image after the matching; and matching a person feature of the second image to a person feature of the first image after the first gaze feature is corrected.

In some embodiments, the step of correcting the first gaze feature includes: correcting the first gaze feature to a second gaze feature according to a deep learning result, where the deep learning result corresponds to a plurality of pieces of learning data, the learning data including a plurality of human eye images, corrected gaze angles of the human eye images, and the human eye images after gaze angle correction.

In some embodiments, a plurality of facial features are determined according to the first image; a head orientation direction is determined according to the facial features; and when the head orientation direction is not directed towards an image capture device, a step of determining whether the first gaze direction is directed towards a position of the image capture device is skipped.

In some embodiments, it is determined, according to the first gaze feature, whether a target is in a blink state; and when the target is in the blink state, a step of determining whether the first gaze direction is directed towards a position of an image capture device is skipped.

In some embodiments, a plurality of facial features are determined according to the first image; it is determined, according to the facial features, that whether a distance to an image capture device is less than a preset distance value; and when the distance is less than the preset distance value, a step of determining whether the first gaze direction is directed towards a position of the image capture device is skipped.

### BRIEF DESCRIPTION OF THE DRAWINGS

FIG. 1 is a schematic block diagram of an electronic device to which a gaze direction correction method is applied according to an embodiment of the present invention.

FIG. 2A is a flowchart of a gaze direction correction method according to an embodiment of the present invention.

FIG. 2B is a schematic diagram of a gaze zone of an image capture device and a gaze of a target according to the present invention.

FIG. 2C is a schematic diagram of a scenario in which a gaze of a target fails to fall within a gaze zone of an image capture device according to the present invention.

FIG. 2D is a schematic diagram of selecting a second image by a gaze correction model according to the present invention.

FIG. 3 is a flowchart of another embodiment of the flowchart in FIG. 2A.

FIG. 4 is a schematic diagram of a difference image between a first eye image and a second eye image respectively being covered by image masks according to the present invention.

FIG. 5 is a flowchart of another embodiment of the flowchart in FIG. 2A.

FIG. 6 is a schematic diagram of combining a first image and a second image.

### DETAILED DESCRIPTION

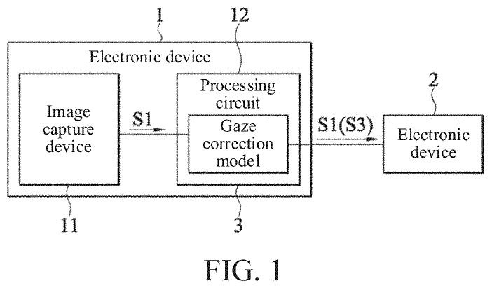

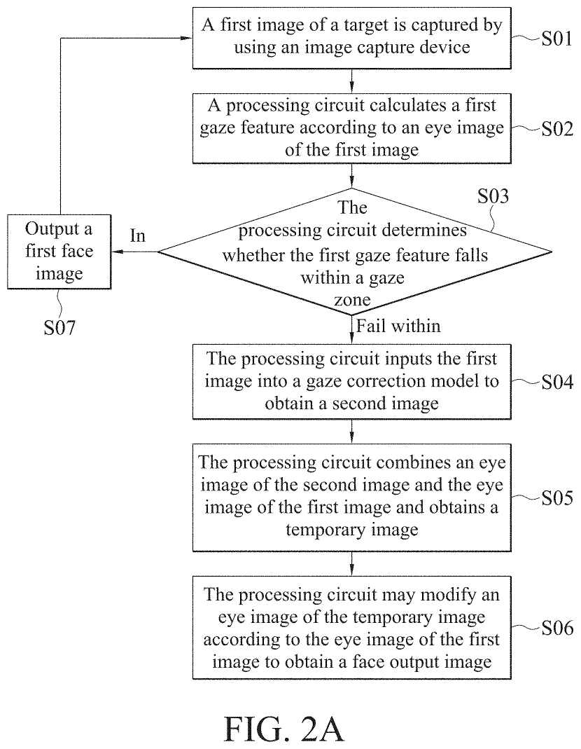

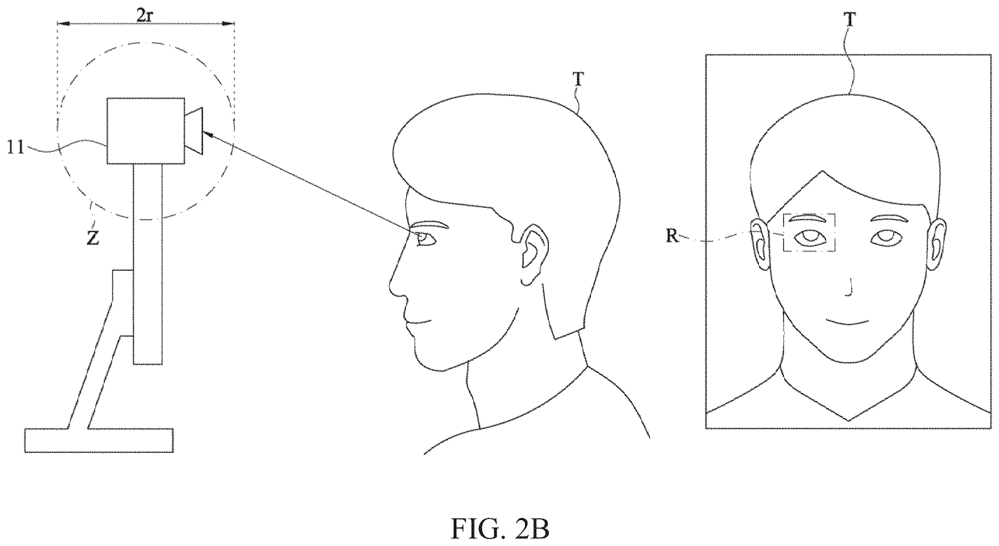

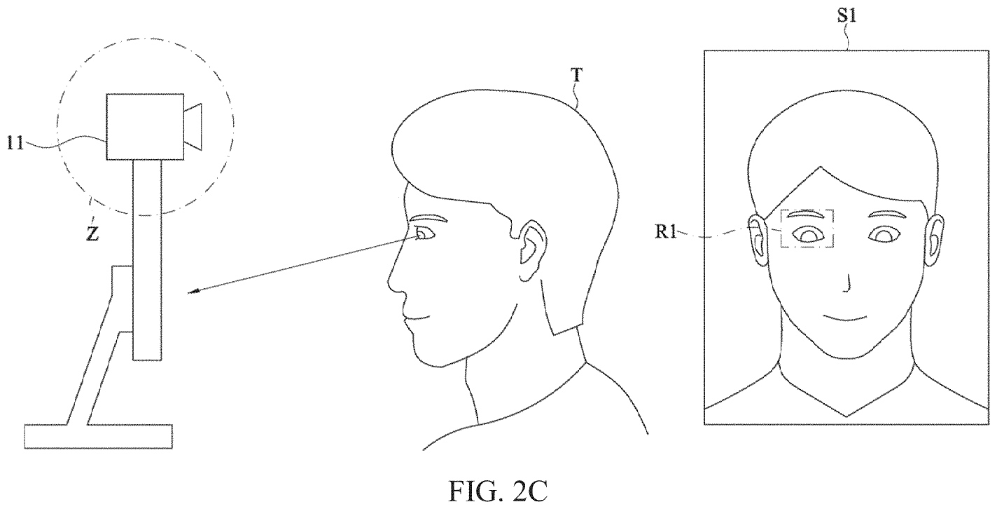

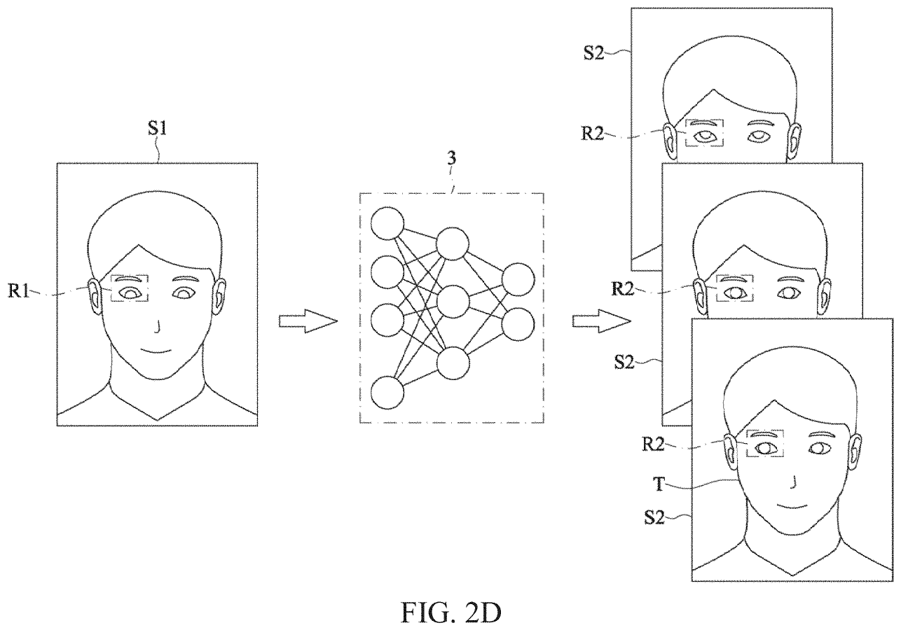

FIG. 1 is a schematic block diagram of an electronic device to which a gaze direction correction method is applied according to an embodiment of the present invention. FIG. 2A is a flowchart of a gaze direction correction method according to an embodiment of the present invention. Referring to FIG. 1 and FIG. 2A, an electronic device 1 includes an image capture device 11 and a processing circuit 12. The image capture device 11 is coupled to the processing circuit 12. When a face of a target is in an image capture range of the image capture device 11, the image capture device 11 captures a first image S1 of the target (step S01). The image capture device 11 sends the first image S1 to the processing circuit 12.

Referring to FIG. 2B and FIG. 2C, the processing circuit 12 calculates a first gaze feature according to an eye image R1 of the first image S1 (step S02). The processing circuit 12 may identify a facial feature of a target T in the first image S1, and define an eye image R (as shown in FIG. 2B) based on a position of the feature on the face. The processing circuit 12 determines whether the first gaze feature is in a gaze zone Z (as shown in FIG. 2C) (step S03). The gaze zone Z may be an area centered by a position of the image capture device 11, or may be a surrounding space of the image capture device 11. FIG. 2B shows that a gaze feature of the target T is in the gaze zone Z. FIG. 2C shows that a gaze feature of the target T is not in the gaze zone Z. The processing circuit 12 calculates a feature vector (hereinafter referred to as a gaze feature) of the gaze according to an eyeball (which is non-white parts of the eye such as a pupil and iris) of the target T and the image capture device 11.

In a video conference scenario, the image capture device 11 is usually placed on the top or the bottom a screen, but not limited thereto. The processing circuit 12 set a space formed by using r as a radius with the image capture device 11 in the center as the gaze zone Z. Refer to a dashed-line range around the image capture device 11 in FIG. 2B. FIG. 2B is a schematic diagram of the gaze zone Z of the image capture device and the gaze feature of a target T according to the present invention. To the left of FIG. 2B shows a scenario that a target T and an image capture device 11 are located at a specific relative position (which are only examples but are not limited thereto). To the right of FIG. 2B shows a digital image of the target T captured by the image capture device 11 in the foregoing scenario. A gray dashed-line block in the digital image represents an eye image (which may correspond to a gaze feature). As shown in FIG. 2B, the target T gazes at the image capture device 11. Therefore, a gaze of the target T is in the gaze zone Z.

When the processing circuit 12 determines that a gaze fails to fall within the gaze zone Z (a determination result shows “not in”), refer to FIG. 2C. FIG. 2C is a schematic diagram of a scenario in which a gaze of a target is not in a gaze zone Z of an image capture device according to the present invention. Certainly, the gaze of the target may alternatively be directed to a horizon direction and is not in the gaze zone Z, which is also considered as the determination result “not in”. The processing circuit 12 inputs the first image S1 into a gaze correction model 3 (step S04), to obtain a second gaze feature and a second image S2 of the target T.

The processing circuit 12 executes the gaze correction model 3. The gaze correction model 3 is a result of machine learning and training obtained according to a face image of the target T (the process is described below in detail). The gaze correction model 3 in the following may include data used for training a model and a training result. In addition to recognizing the face image and the gaze feature of the target T, the gaze correction model 3 further records face images in which the gaze feature of the target T falls within the gaze zone Z at different rotation angles. FIG. 2D shows a second image S2 selected by a gaze correction model in some embodiments according to the first image S1. The gaze correction model 3 may select at least one second image S2. The second image S2 includes an eye image R2 of the target T (e.g., an uppermost image in which the target correctly gazes at the image capture device 11 may be selected, and the eye image R2 included in the uppermost image has a gaze feature similar to that shown in FIG. 2B). The processing circuit 12 may calculate the second gaze feature according to the second image S2 and the eye image R2.

Then, the processing circuit 12 combines the eye image R2 of the second image S2 and the first image S1 according to the second gaze feature, and obtains a temporary image (step 505). To avoid an unnatural phenomenon or a discontinuous phenomenon generated at a boundary of an eye image in the temporary image or noises generated in an eye image that is not correction-required, the processing circuit 12 may modify the eye image in the temporary image according to the eye image R1 of the first image S1 (step S06), to obtain a relatively natural face output image S3.

In some embodiments, when the target T communicates with another electronic device 2 in a manner of a video call through a wired network or a wireless network by using an electronic device 1, the electronic device 2 may receive the face image (S1 or S3) of the target T. If the target T does not gaze at the image capture device 11, a user of the electronic device 2 may see the face output image S3 combined by using the processing circuit 12. A gaze direction of the target T in the face output image S3 is directed towards the image capture device 11. Such an effect may improve a visual communication between a user of the electronic device 2 and a user of the electronic device 1 (i.e., the target T in this embodiment).

In some embodiments, the image capture device 11 may be an RGB image capture device to generate the first image S1, the second image S2, and the face output image S3 that are RGB images. The electronic device 1 may be a notebook computer, a tablet computer, or a mobile phone. The image capture device 11 may be a camera of a notebook computer, a camera of a tablet computer, or a camera of a mobile phone. The processing circuit 12 may determine a difference between the first image S1 and the foregoing second image S2 including the second gaze feature, to obtain a pixel position of a corrected pixel. The image capture device 11 captures the target T in a manner of steaming. Especially, the image capture device 11 is a device supporting photography at a high frame rate, for example, a camera capturing 30 frames per second. When the target T is on a video call, for two consecutive frames of digital images, face images of the target T are predicted to be similar (which means that face positions are close). Therefore, the processing circuit 12 may determine, according to a plurality of consecutive frames of images, whether a position of a human face is changed, and whether the face rotates.

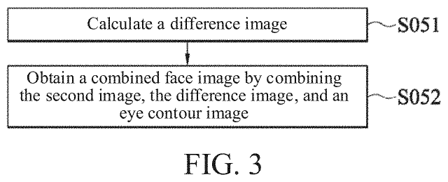

In some embodiments, referring to FIG. 3, the processing circuit 12 may perform smoothing on a single frame of the temporary image obtained in step 505. For example, the processing circuit 12 obtains a difference image between the first image S1 and the second image S2 by performing subtraction on pixel data corresponding to identical pixel positions in the first image S1 and the second image S2 (i.e., pixels having the same position with respect to each frame) to calculate pixels having differences and corresponding pixel differences (step S051).

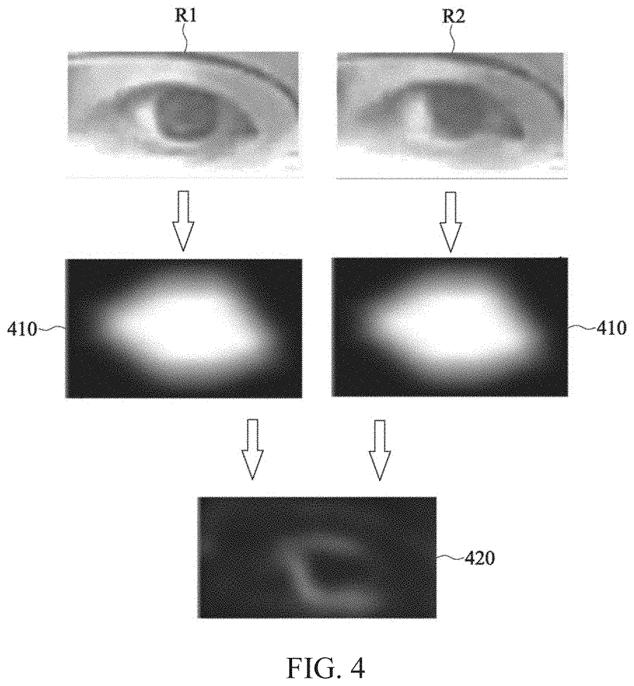

The processing circuit 12 generates an image mask to represent an eye contour image of an eye area. An image mask 410 may use a manner of a blur filter or the like, for example, a low-pass filter or a median filter. The processing circuit 12 obtains a difference image 420 of an eye after the eye image is covered by the image mask 410. FIG. 4 is a schematic diagram of a difference image between a first eye image and a second eye image respectively being covered by image masks according to the present invention. For an image mask 410 in FIG. 4, a white color is used for representing an eye area and a black color is used for representing facial skin of a non-eye area. In a difference image 420, corrected pixels are displayed in white, and uncorrected pixels are displayed in black. A grayscale color represents the level of correction. A higher correction level corresponds to a whiter color. In contrast, a lower correction level corresponds to a blacker color. An eye image R1 and an eye image R2 are respectively covered by image masks 410 to obtain a difference image 420.

The processing circuit 12 further obtains a combined face image of the target T by combining the second image S2, the difference image 420, and the eye contour image. (step S052). In this embodiment, problems such as an unnatural or a discontinuous phenomenon, or noises generated in an eye area that is not correction-required may be reduced in the combined face image compared with the second image S2. The processing circuit 12 may directly output the combined face image to be used as the face output image S3.

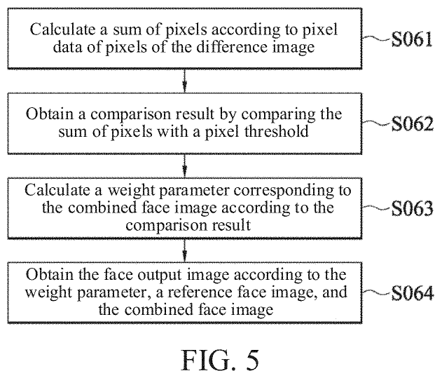

In some embodiments, referring to FIG. 5, a smoothing procedure may be performed on two consecutive frames of images according to the difference image 420 obtained in step S051 and the combined face image obtained in step S052, to generate the face output image S3. If only one of the two consecutive frames of images is corrected, a problem of bouncing eyeball (i.e., discontinuous eye image) may occur in the consecutive images. In steps S061-S064, in a process of obtaining the face output image S3 through combination, the processing circuit 12 may execute an image smoothing procedure, and output the face output image S3 to the electronic device 2.

In the image smoothing procedure, the processing circuit 12 may add up pixel values at pixel positions in the difference image 420, to calculate a sum Σdiff of pixels (step S061). Then the processing circuit 12 obtains a comparison result by comparing the sum Σdiff of pixels with a pixel threshold TH (step S062). The processing circuit 12 may obtain a difference as the comparison result by performing subtraction on the sum Σdiff and the pixel threshold TH. The processing circuit 12 further calculates a weight parameter α^{t} corresponding to the combined face image by using the comparison result (e.g., according to a formula 1.1) (step S063), and the weight parameter α^{t} is less than 1.

Before the image capture device 11 captures the first image S1, the image capture device 11 may capture another face image of the target T at another time point. For example, the image capture device 11 may capture another face image of the target T at an earlier first time point, and capture the first image S1 at a later second time point. The another eye image corresponding to the first time point may be used as a reference face image for the processing circuit 12 to perform the image smoothing procedure, so that the processing circuit 12 obtains the face output image S3 according to the weight parameter α^{t}, the reference face image, and the combined face image (e.g., according to a formula 1.2) (step S064). The weight parameter α^{t} is used as a first weight parameter, and (1−α^{t}) is used as a second weight parameter below.

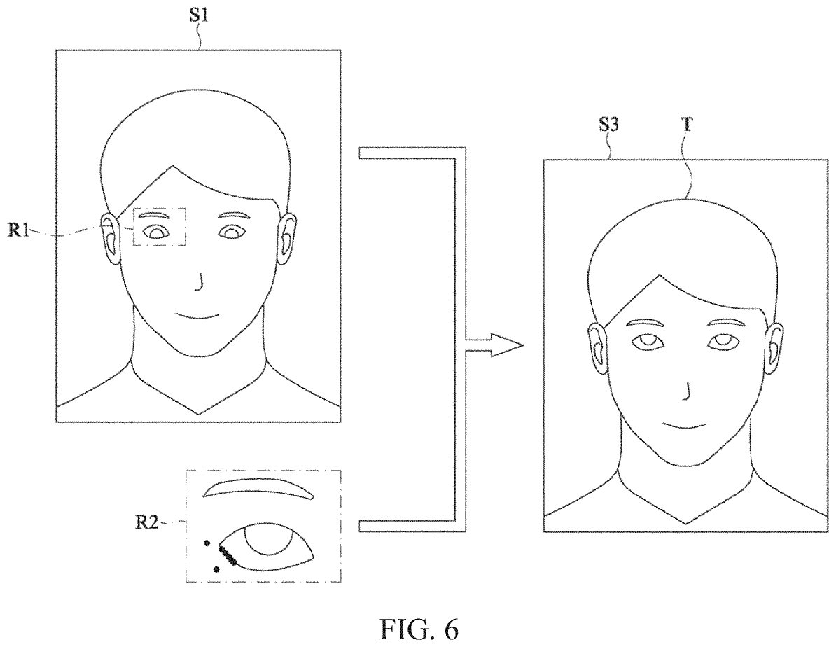

In step S064, the processing circuit 12 may obtain a first pixel product by multiplying a pixel value of each pixel position of the combined face image by the first weight parameter α^{t}. As shown in FIG. 6, the processing circuit 12 obtains the second weight parameter (1−α^{t}) by subtracting the first weight parameter α^{t} from 1, and obtains a second pixel product by multiplying the second weight parameter (1−α^{t}) by a pixel value of each pixel position of the reference face image. The processing circuit 12 further obtains a pixel value of each pixel position of the combined face image after the smoothing procedure by adding up the first pixel product and the second pixel product that correspond to each pixel position. The processing circuit 12 further outputs the combined face image after the smoothing procedure as the face output image S3. In FIG. 6, a block surrounded by a gray dashed line is used for representing noises of the second image S2 and of the eye image thereof.

$$\begin{matrix}{α}^{t} = \frac{1}{2} \times ( \frac{\sum ( {diff}_{img} ) - TH}{TH} + {α}^{t - 1} ) & Formula 1.1 \\ {T}_{{I}_{x , y}^{t}} = ( 1 - {α}^{t} ) {I}_{x , y}^{- 1} + {α}^{t} {T}_{{I}_{x , y}^{t}} & Formula 1.2\end{matrix}$$

α^{t} is a proportion parameter of a current frame; α^{t-1} is a proportion parameter of a previous frame; TH is a threshold for determining a sum of pixels of an image; I_{x,y}^{t} is a pixel value of the current frame on the x-axis and the y-axis; and I_{x,y}^{t-1} is a pixel value of the previous frame on the x-axis and the y-axis. From the formula 1.1, it may be learned that, if the sum Σdiff of pixels is larger, the first weight parameter at calculated by the processing circuit 12 is larger. That is, the face output image S3 after the smoothing includes a larger quantity of pixel data of the combined face image and a smaller quantity of pixel data of the reference face image. On the contrary, if the sum Σdiff of pixels is smaller, the first weight parameter at calculated by the processing circuit 12 is smaller. That is, the face output image S3 after the smoothing procedure includes a smaller quantity of pixel data of the combined face image and a larger quantity of pixel data of the reference face image. Based on the above, an afterimage on the face output image S3 may be avoided by referring to the combined face image and the reference face image by the processing circuit 12.

In some embodiments, in the image smoothing procedure, the processing circuit 12 may also determine, according to the sum Σdiff of pixels, whether the eyeball of the target T is in a rotation state, or whether the face is in a rotation state. The processing circuit 12 may determine whether the sum Σdiff of pixels is greater than a threshold that may be used for distinguishing whether the eye ball is in the rotation state and whether the face is in the rotation state. When the sum Σdiff of pixels is greater than the threshold, the processing circuit 12 may determine to skip executing the image smoothing procedure. When the sum Σdiff of pixels is less than the threshold, the processing circuit 12 determines to execute the image smoothing procedure.

In some embodiments, the processing circuit 12 may execute a histogram of oriented gradients (HOG) algorithm to position the face and the eye in the first image S1, to position a plurality of sets of gaze features of the target T in the first image S1. In addition, a plurality of first images S1 of the target T captured by the image capture device 11 at different time may have different color brightness and background colors. Therefore, the processing circuit 12 may perform the smoothing procedure on the plurality of first images S1 by using the optical flow according to the plurality of first images S1 of the target T captured by the image capture device 11 at different time, to position a stable face position and a stable eye position.

In some embodiments, the gaze correction model 3 may correct a gaze direction of the target T by using a learning result of deep learning. Specifically, at a learning stage, the gaze correction model 3 receives two pieces of learning data including input learning data and output learning data. The input learning data includes a human eye image and a to-be-corrected gaze angle. The human eye image may be a combined image or a real image of a human eye. The gaze angle may be represented by using a two-dimensional vector. That is, the gaze angle may include an angle in a direction X and an angle in a direction Y. The output learning data includes a corrected human eye image. The processing circuit 12 performs the deep learning based on the learning data and generates a result of the learning. The gaze correction model 3 obtains the second image S2 according to the result of the learning in step S04. The second image S2 includes a corrected gaze direction. In some embodiments, the processing circuit 12 may perform deep learning training by using warping in a CNN model, an Encoder-Decoder architecture or a model architecture based on a GAN in step S04.

In some embodiments, referring to FIG. 2A, based on the human eye image used in the deep learning, the first image S1 and the human eye image used for performing the deep learning have a consistent image region. For example, the first image S1 and the human eye image used for performing the deep learning have consistent pixel data (for example, contrast and chromaticity) and person feature information (e.g., a color of skin). In step S02, before determining the gaze direction, the processing circuit 12 may match a gaze feature of the first image S1 to a gaze feature of the human eye image in the learning data and the learning result based on the HOG algorithm, to enable the contrast, the chromaticity, and the person feature information of the first image S1 to be consistent with the gaze correction model 3. The processing circuit 12 further determines the gaze direction of the target T according to the first image S1 after the matching (step S02). The processing circuit 12 may obtain the second image S2 by performing deep learning by using the gaze correction model 3 in step S02. Then, after obtaining the second image S2 by correcting the gaze direction of the first image S1, the processing circuit 12 further matches the contrast, the chromaticity, and person feature information of the second image S2 to be consistent with that of the first image S1 (step S04), to reduce a color deviation of two frames of images caused by the gaze correction model 3.

In some embodiments, if the head of the target T is not directed towards the image capture device 11, the processing circuit 12 may determine a head orientation angle of the target T according to a plurality of facial features of the first image S1, for example, a specific orientation defined by using feature values of the face such as positions of facial parts or a change of a relative distance. The processing circuit 12 compares the head orientation angle with a range of an angle directed towards the image capture device 11. If the processing circuit 12 determines that the head orientation angle is out of the range of the angle directed towards the image capture device 11, that is, the head orientation direction of the target T is not directed towards the image capture device 11, the processing circuit 12 does not perform gaze correction and outputs the first image S1 (step S07). Alternatively, the processing circuit 12 may determine, according to the plurality of facial features of the first image S1, whether the first image S1 includes a side face image of the target T. If the first image S1 includes the side face image of the target T, that is, the head orientation direction of the target T is not directed towards the image capture device 11, and the head orientation angle is out of the range of the angle directed towards the image capture device 11, the processing circuit 12 does not perform gaze correction and outputs the first image S1 (step S07).

In some embodiments, if the target T is in a blink state, the first image S1 captured by the image capture device 11 does not include a gaze direction. The processing circuit 12 determines, according to the first image S1, whether the target T is in the blink state. The processing circuit 12 may determine, by using feature points of the eye area, whether the target T is in the blink state. The processing circuit 12 determines a distance (hereinafter referred to as a first distance) from an uppermost feature point to a lowest feature point in the eye area, a distance (hereinafter referred to as a second distance) from a leftmost feature point to a rightmost feature point, and calculates a ratio of the first distance to the second distance. The processing circuit 12 compares the ratio with a threshold that may be used for distinguishing a blink state from an unblinking state. If the ratio is less than the threshold (a determination result is “no”), it indicates that the target T is in the blink state, the processing circuit 12 does not perform gaze correction and outputs the first image S1 (step S07).

In some embodiments, when the target T is excessively close to or excessively far away from the image capture device 11, if the processing circuit 12 corrects the gaze direction of the target T to be directed towards the image capture device 11, a gaze direction of the face output image S3 outputted by the image capture device 11 is relatively unnatural. Therefore, in step S04, the processing circuit 12 may determine a distance between the image capture device 11 and the target T based on positions of the facial feature points of the first image S1. Then, the processing circuit 12 determines whether a distance between the target T and the image capture device 11 is less than a preset distance value. In a case that the distance is less than the preset distance value, the processing circuit 12 determines that a first gaze direction of the first image S1 is not correction-required, and the processing circuit 12 does not perform correction on the first image S1 and outputs the first image S1 (step S07).

In some embodiments, the processing circuit 12 may be implemented by a central processing unit (CPU) or a microprogrammed control unit (MCU), or supplemented by a graphics processing unit (GPU).

Based on the above, according to an embodiment of the gaze direction correction method of the present invention, when a lens of an electronic device is disposed around a screen and is not placed in a central region of the screen, the electronic device may correct a captured image (which is mainly an eye image) of a user's face, so that a gaze direction of the user seems to be directed towards the lens of the electronic device, and a sense of visual communication can be generated between users during a video call by using different electronic devices. In addition, the electronic device may perform extra image processing on an eye image in a video image. The electronic device reduces noises of the eye image, and performs smoothing procedure according to eye images captured by using an image capture device at different time points, and the electronic device may unify and optimize a gaze correction procedure through a model training in a machine learning method, to output video face images with better image quality.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A gaze direction correction method, comprising:
obtaining a first image;
obtaining a first gaze feature according to the first image;
determining whether the first gaze feature falls within a gaze zone;
if the first gaze feature fails to fall within the gaze zone, obtaining, according to the first image, a second image corresponding to the first image and obtaining an eye image corresponding to the second image;
obtaining a temporary image by combining the first image and the eye image; and
obtaining a face output image by modifying the temporary image.

2. The gaze direction correction method according to claim 1, wherein the step of obtaining a face output image by modifying the temporary image comprises:
obtaining a difference image by calculating a pixel difference between the first image and the second image and corresponding to identical pixel positions; and
obtaining the face output image by combining the second image, the difference image, and an eye contour image of the first image.

3. The gaze direction correction method according to claim 1, wherein the step of obtaining a face output image by modifying the temporary image further comprises:
obtaining a reference face image before the first image is obtained;
obtaining a difference image by calculating a pixel difference between the identical pixel positions of the first image and the second image;
calculating a sum of pixels according to pixel data of each pixel of the difference image;
obtaining a comparison result by comparing the sum of pixels with a pixel threshold;
obtaining a combined face image by combining the second image, the difference image, and an eye contour image of the first image;
calculating a first weight parameter corresponding to the combined face image according to the comparison result; and
obtaining the face output image according to the first weight parameter, the reference face image, and the combined face image.

4. The gaze direction correction method according to claim 3, wherein a sum of the first weight parameter and a second weight parameter is one, and the step of obtaining the face output image according to the first weight parameter, the reference face image, and the combined face image comprises:
obtaining a first pixel product by multiplying the first weight parameter by pixel data of the combined face image;
obtaining a second pixel product by multiplying the second weight parameter by pixel data of the reference face image; and
obtaining pixel data of the face output image by adding up the first pixel product and the second pixel product.

5. The gaze direction correction method according to claim 1, wherein after the step of obtaining a first image, the method comprises:
obtaining a first gaze direction according to the first image;
before the first gaze direction is determined, matching pixel data of the first image with pixel data of a plurality of human face images comprised in a gaze correction model, and correcting the first gaze feature according to the first image after the matching; and
matching pixel data of the second image to the pixel data of the first image after the first gaze feature is corrected.

6. The gaze direction correction method according to claim 5, wherein the step of correcting the first gaze feature comprises:
correcting the first gaze feature to a second gaze feature according to a deep learning result, wherein the deep learning result corresponds to a plurality of pieces of learning data, the learning data comprising a plurality of human eye images, corrected gaze angles of the human eye images, and the human eye images after gaze angle correction.

7. The gaze direction correction method according to claim 5, further comprising:
determining a plurality of facial features according to the first image;
determining a head orientation direction according to the facial features; and
when the head orientation direction is not directed towards an image capture device, skipping determining whether the first gaze direction is directed towards a position of the image capture device.

8. The gaze direction correction method according to claim 5, further comprising:
determining, according to the first gaze feature, whether a target is in a blink state; and
when the target is in the blink state, skipping determining whether the first gaze direction is directed towards a position of an image capture device.

9. The gaze direction correction method according to claim 5, further comprising:
determining a plurality of facial features according to the first image;
determining, according to the facial features, whether a distance to an image capture device is less than a preset distance value; and
when the distance is less than the preset distance value, skipping determining whether the first gaze direction is directed towards a position of the image capture device.

10. The gaze direction correction method according to claim 1, wherein after the step of obtaining a first image, the method comprises:
obtaining a first gaze direction according to the first image;
before the first gaze direction is determined, matching the first gaze feature with gaze features of a plurality of human eye images comprised in a gaze correction model, and correcting the first gaze feature according to the first image after the matching; and
matching a person feature of the second image to a person feature of the first image after the first gaze feature is corrected.

11. The gaze direction correction method according to claim 10, wherein the step of correcting the first gaze feature comprises:
correcting the first gaze feature to a second gaze feature according to a deep learning result, wherein the deep learning result corresponds to a plurality of pieces of learning data, the learning data comprising a plurality of human eye images, corrected gaze angles of the human eye images, and the human eye images after gaze angle correction.

12. The gaze direction correction method according to claim 10, further comprising:
determining a plurality of facial features according to the first image;
determining a head orientation direction according to the facial features; and
when the head orientation direction is not directed towards an image capture device, skipping determining whether the first gaze direction is directed towards a position of the image capture device.

13. The gaze direction correction method according to claim 10, further comprising:
determining, according to the first gaze feature, whether a target is in a blink state; and
when the target is in the blink state, skipping determining whether the first gaze direction is directed towards a position of an image capture device.

14. The gaze direction correction method according to claim 10, further comprising:
determining a plurality of facial features according to the first image;
determining, according to the facial features, whether a distance to an image capture device is less than a preset distance value; and
when the distance is less than the preset distance value, skipping determining whether the first gaze direction is directed towards a position of the image capture device.
